(19) United States
(12) Patent Application Publication
(10) Pub. No.: US 2018/0096428 A1
(43) Pub. Date: Apr. 5, 2018

(54) METHODS, SYSTEMS, AND NETWORKS, FOR PROACTIVE CURRENCY EXCHANGE

(71) Applicant: MASTERCARD INTERNATIONAL INCORPORATED, Purchase, NY (US)

(72) Inventor: Alan Gorenstein, Fairfield, CT (US)

(73) Assignee: MASTERCARD INTERNATIONAL INCORPORATED, Purchase, NY (US)

(21) Appl. No.: 15/282,725

(22) Filed: Sep. 30, 2016

(51) Int. Cl. G06Q 40/04; G06Q 40/02

(52) U.S. Cl. CPC G06Q 40/04; G06Q 40/02

(57) ABSTRACT

A method for performing proactive currency exchange can include receiving, by a processor, a request from an account member to exchange at least a portion of funds in the member account from a current currency of the funds to at least one alternative currency. The member account can be a pre-paid payroll account, a pre-loaded prepaid account, or a credit card account with a balance that favors the cardholder. In response to receiving the request, the process can determine whether account holder pre-specified criteria have been met to proceed with the proactive currency exchange process, and whether there are sufficient funds in the member account to perform the requested currency exchange. The processor can perform a proactive currency exchange to exchange at least the portion of funds in the member account from the current currency to the at least one alternative currency.

### BACKGROUND

The disclosed subject matter relates to methods, systems, and networks for performing proactive currency exchange.

With the increase in magnitude and sources of social, political, and economic instability globally, many local economies have become subject to increased instability. As a result of such fluctuations in economic, political, and other forms of risk, local currencies are subject to devaluation. In certain areas of the world that are subject to substantial inflation, local residents often experience an acute need to purchase daily items (e.g., groceries, medications, etc.) as soon as they are paid, and to spend the money they earn in their domestic currencies immediately, because those currencies lose value at an accelerated rate and the purchasing power of their saved assets rapidly dissipates over time. Separately, there are areas of monetary, political, economic, and other types of risk where the loss of currency value is not continuous, but rather sudden. For example, invasion, governmental miscalculations, and regime instability can cause a sudden dip in the domestic currency value. In these cases, a domestic currency's value can either be reduced, or its value could completely terminate.

Currently, individuals living in these areas of financial instability face the risk of a personal financial crisis and have no convenient means by which to safeguard their assets. Many individuals living in such areas of social, political, and economic instability do not have easy access to foreign currencies, and those that do have such access can find that, in times of crisis, when their needs are most severe, banks and other financial institutions have been closed. In certain circumstances, internet, electricity, telecommunications services, and other means of communication and utilities can also be terminated following domestic governmental action, malware attack, strategic bombing, and other such catastrophic events. Accordingly, such individuals' financial assets are limited to the local and/or current currency in which their assets are typically stored in (e.g., the local and/or domestic currency), which can be subject to rapid fluctuations in value. It can be an economic inconvenience, or even an economic catastrophe, for these individuals to be fully exposed to a singular at-risk currency and to not have the option to exchange their funds from their current currency into a different currency.

Accordingly, there exists a need for techniques by which individuals can protect their financial assets from such fluctuations in economic instability.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a method for performing a proactive currency exchange from a local and/or current currency into an alternative currency is disclosed. The method can include receiving, by a processor, a request from an account member to exchange at least a portion of funds in the member account from a local and/or current currency to at least one alternative currency. In some embodiments, the request from the account member can be an immediate request, a recurring request (e.g., a request based on a deposit from a specific source), or a conditional request (e.g., a request based on preset risk criteria and/or foreign exchange conditions). In response to receiving the request, the processor can determine whether there are sufficient funds in the member account to perform the requested currency exchange. The processor can perform a currency exchange to exchange at least a portion of funds in the member account from the local and/or current currency to the at least one alternative currency.

In some embodiments, the current currency can be the local currency associated with a current location of the cardholder. The alternative currency can be a currency that is determined to have a level of stability above a preset threshold. The member account can be associated with at least one of a pre-paid debit card, reloadable debit card, gift card, credit card with a positive credit, and payroll card.

In some embodiments, the processor can determine whether the current currency is subject to fluctuation above a predetermined level by transmitting notification information to a user device associated with the account member. The notification information can indicate that the current currency of the account member is subject to fluctuation and can provide an option for the account member to initiate a request to exchange at least the portion of the funds in the member account from the current currency to the at least one alternative currency. A level of risk can be calculated by monitoring a plurality of internal transactional data (e.g., foreign currency exchange requests and other types of transaction data indicating that cardholders are exchanging funds in a given currency for other types of assets), customer inquiries, and external news information sources for events indicating at least one of social risk, political risk, and economic risk and determining the level of risk to the current currency based on the monitoring.

In some embodiments, performing the proactive currency exchange can include exchanging a first portion of the funds from the current currency to a first amount in a first alternative currency and exchanging a second portion of the funds from the current currency into a second amount in a second alternative currency. The account member can indicate the first portion and the second portion in the request. The account member can specify the first alternative currency and the second alternative currency in the request.

In some embodiments, the account member can be provided with one or more different alternative currencies from which to select to perform the proactive currency exchange. The processor can receive, from the account member, a selection of the at least one alternative currency from the one or more different alternative currencies. The one or more different alternative currencies provided to the account member can be currencies accepted in at least one of a region in which the account member is located and a region to which the account member is likely to relocated based upon migratory patterns of refugees and stateless populations.

In some embodiments, performing the proactive currency exchange can include instructing, by the processor, an issuer of the member account to provide at least the portion of the funds from the member account to a third-party financial institution. The processor can instruct the third-party financial institution to exchange the at least the portion of the funds provided by the issuer from the current currency to an amount of exchanged funds in the at least one alternative currency. The processor can instruct the third-party financial institution to transmit the amount of exchanged funds in the at least one alternative currency from the third party financial institution to the issuer for deposit in the member account.

In some embodiments, the member account can be associated with a payment card and the transactions conducted using the payment card after the proactive currency exchange can be conducted in the at least one alternative currency.

In some embodiments, positive (e.g., consumer favoring) balances in the member account in the current currency after the request is received can be automatically exchanged into the at least one alternative currency until a request to stop performing the proactive currency exchange is received from the account member. Such automatic currency exchanges can occur either at the time the positive balance exhibits itself or based on a time when a pre-set criteria related to the account, the internal data, the external data, or a combination thereof is satisfied.

In some embodiments, determining whether there are sufficient funds in the member account to perform the requested currency exchange can include transmitting, by the processor, a message to an issuer of the member account indicating an exchange fee for performing the proactive currency exchange and a query to determine whether there are sufficient funds in the member account to cover at least the portion of the funds to exchange into the at least one alternative currency and the exchange fee. In response to transmitting the message to the issuer, the processor can be configured to receive, from the issuer, a return message indicating whether there are sufficient funds in the member account to cover at least the portion of the funds to be exchanged into the at least one alternative currency and the exchange fee.

In accordance with another aspect of the disclosed subject matter, an apparatus for performing a currency exchange is disclosed. The apparatus can include a communication module configured to communicate with a currency exchange server. The apparatus can include a processor, coupled to the communication module that is configured to receive a request from an account member to exchange at least a portion of funds in a member account from a current currency of the funds to at least one alternative currency. In response to receiving the request, the processor can be configured to determine whether there are sufficient funds in the member account to perform the requested currency exchange. The processor can be configured to instruct the currency exchange server to perform a proactive currency exchange to exchange at least the portion of funds in the member account from the current currency to the at least one alternative currency.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a representative payment network according to an illustrative embodiment of the disclosed subject matter.

FIG. 2 is a diagram illustrating a system for performing proactive currency exchange according to an illustrative embodiment of the disclosed subject matter.

FIG. 3 is a flow chart illustrating a representative method, for performing proactive currency exchange, implemented according to an illustrative embodiment of the disclosed subject matter.

FIG. 4 is a block diagram illustrating further details of a representative computer system according to an illustrative embodiment of the disclosed subject matter.

Throughout the drawings, the same reference numerals and characters, unless otherwise stated, are used to denote like features, elements, components or portions of the illustrated embodiments. Moreover, while the present disclosed subject matter will now be described in detail with reference to the figures, it is done so in connection with the illustrative embodiments.

### DETAILED DESCRIPTION

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The methods, systems, networks, and media presented herein can be used for performing a proactive currency exchange from a local and/or current currency into one or more alternative currencies.

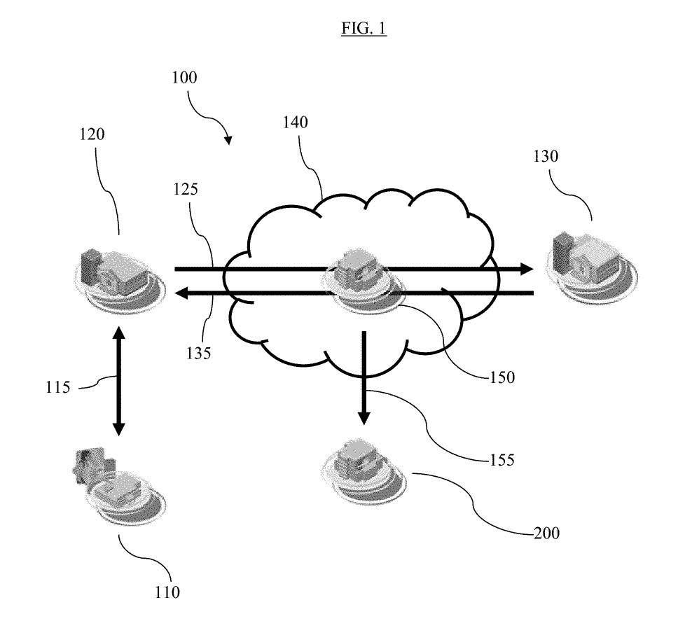

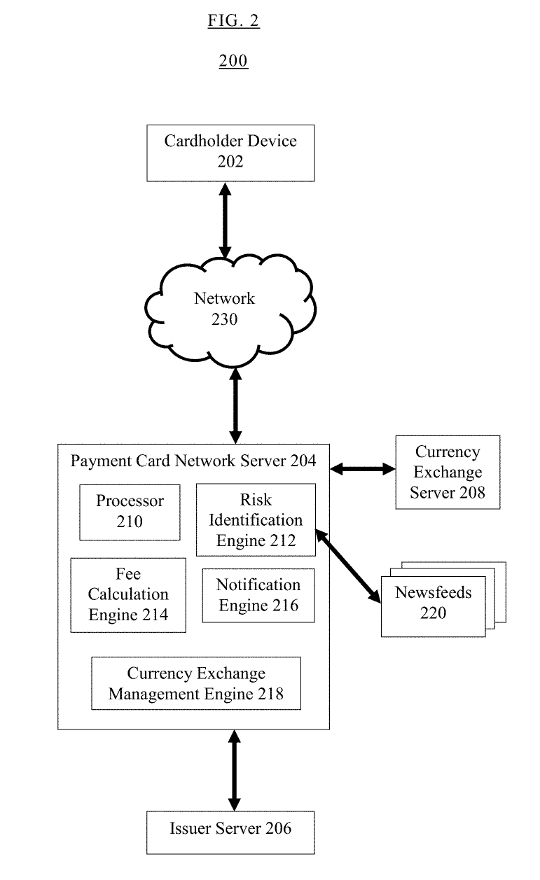

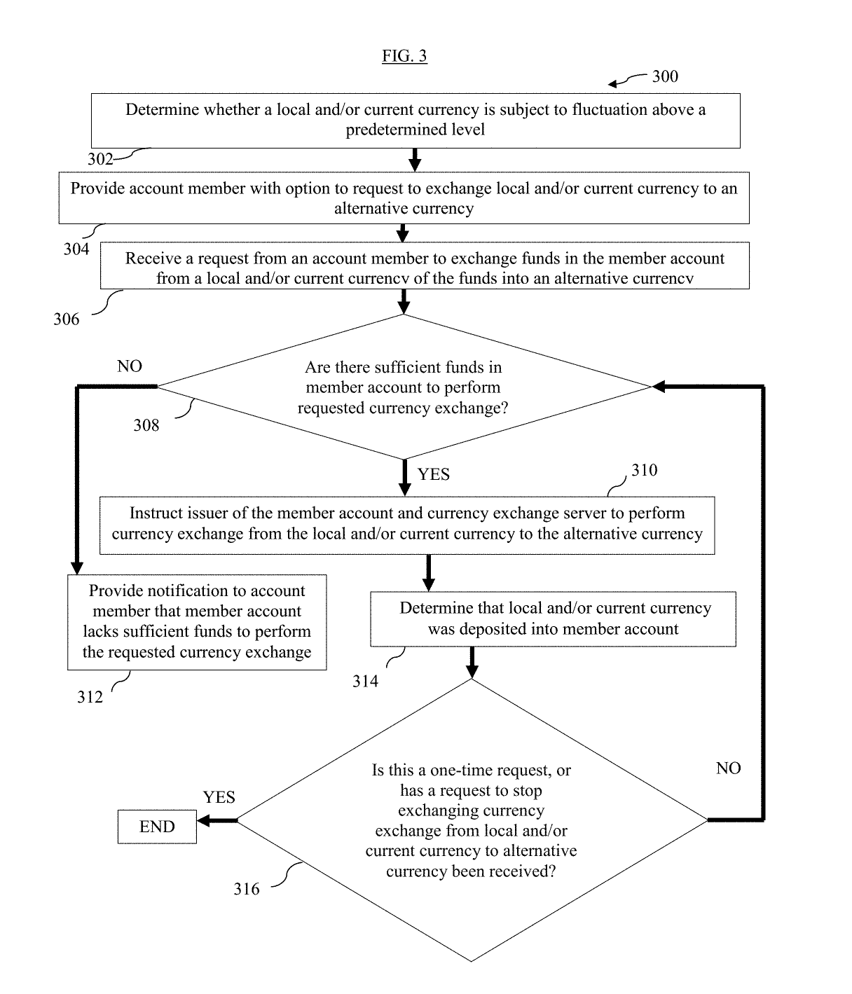

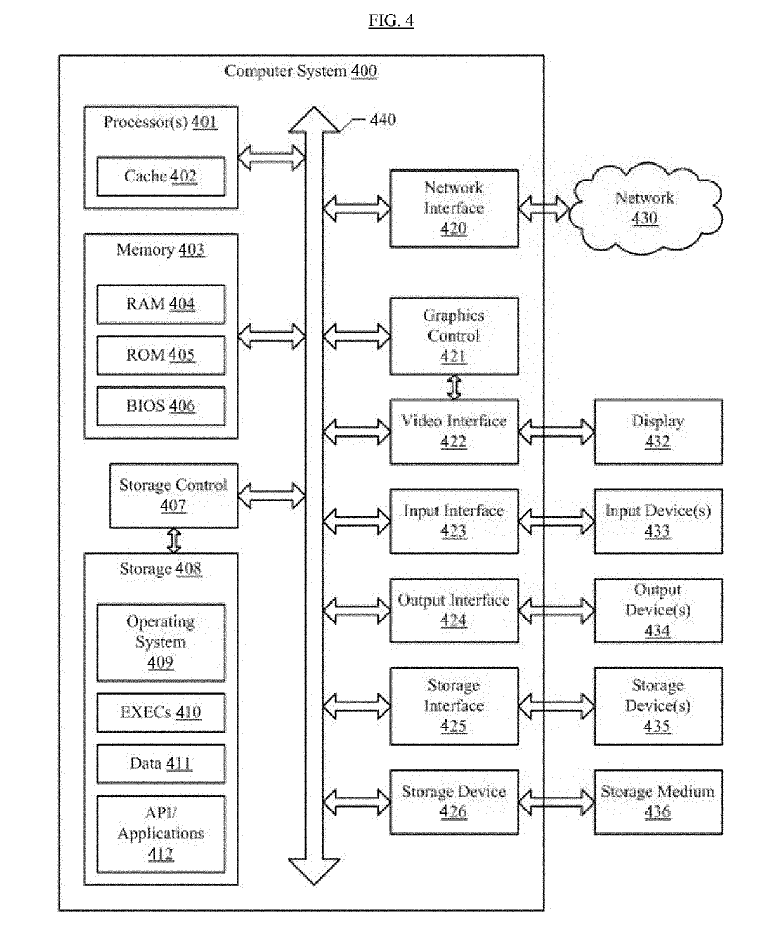

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, an exemplary embodiment of a payment network for predicting acceptance of a commercial card product in accordance with the disclosed subject matter is shown in FIG. 1. FIG. 2 shows an exemplary block diagram of a system for performing proactive currency exchange in accordance with the disclosed subject matter. FIG. 3 shows an exemplary embodiment of a method for performing proactive currency exchange in accordance with the disclosed subject matter. An exemplary embodiment of a computer system for use with the disclosed subject matter is shown in FIG. 4. While the present disclosed subject matter is described with respect to using methods, systems, and networks, for performing proactive currency exchange, one skilled in the art will recognize that the disclosed subject matter is not limited to the illustrative embodiments. For example, the methods, systems, and networks for performing proactive currency exchange can be used with a wide variety of non-e-commerce transaction settings, such as in-person bank transactions, commodities trading, and a variety of other applications. In some embodiments, the proactive currency exchange transactions can be prescheduled to occur at a future time according to a cardholder's request. In some embodiments, the proactive currency exchange transactions can be scheduled to occur whenever pre-set criteria set by the cardholder and/or the financial institution of the cardholder are satisfied. For example, the cardholder can specify, as pre-set criteria for proactive currency exchange, social media updates and/or posts confirming the cardholder's domestic country's exit from a political union, text mining analysis that indicates a specific nation's increased instability, foreign exchange volume increases from the current currency to an alternate currency, or current currency value ratios to alternate currencies.

FIG. 1 depicts a diagram illustrating a representative payment network 100 according to an illustrative embodiment of the disclosed subject matter. Payment network 100 can allow for payment transactions in which merchants and card issuers do not necessarily have a one-to-one relationship. The payment network 100, for example, and without limitation, a credit card payment system, can utilize an electronic payment network 140, such as the MasterCard® payment card system interchange network. The MasterCard® payment card system interchange network is a proprietary communications standard promulgated by MasterCard International Incorporated® based on the ISO 8583 message format for the exchange of financial transaction data between financial institutions that are customers of MasterCard International Incorporated. (MasterCard is a registered trademark of MasterCard International Incorporated located in Purchase, N.Y.)

As embodied herein, the payment network 100 for determining a discount amount for an electronic commerce transaction can include at least one merchant 110 connected to at least one electronic payment network 140, either directly or through an acquirer 120 via connection 115. At least one acquirer 120 can be connected to the electronic network 140, and each merchant 110 can be in communication with at least one acquirer 120 via the at least one payment network 140 or connection 115. At least one issuer 130 can be connected to the electronic network 140, and each acquirer 120 can be in communication with at least one issuer 130 via the electronic payment network 140.

For purpose of illustration and not limitation, in payment network 100, a financial institution, such as an issuer 130, can issue an account, such as a credit card account, a gift card, a pre-loaded payroll card of an employee that is periodically deposited with funds from an employer, or a debit card account, to a cardholder (e.g., an individual consumer or a corporate or commercial customer), who can use the payment account card to tender payment for a purchase from a merchant 110 or to conduct a transaction at an ATM or website. The disclosed subject matter can be used with a pre-paid card (e.g., a pre-paid payroll card, pre-paid debit card, and/or a gift card). The disclosed subject matter can also be used with a credit card in which, as an example, an excess payment is made to the credit card exceeding the balance amount, creating a positive balance amount above a debt or zero amount that favors the cardholder. In some embodiments, the positive balance on the pre-paid card and/or credit card can be exchanged into multiple different currencies or can be exchanged into a single new alternative currency from the current and/or local currency in which the positive balance is in at that time. Hereinafter, the positive balance on the pre-paid gift card, debit card, credit card, and/or pre-loaded payroll card that the cardholder can use to pay for goods and/or services with will be referred to as the funds and/or assets in the member account. To accept payment with the payment account card, merchant 110 can establish an account with a financial institution that is part of the financial payment system. This financial institution can be referred to as the “merchant bank” or the “acquiring bank,” or herein as “acquirer 120.” When a cardholder tenders payment for a purchase with a payment account card, the merchant, ATM, or website 110 can request authorization from acquirer 120 for the amount of the purchase. The request can be performed over the telephone, online via a website, or through the use of a point-of-sale terminal which can read the cardholder's account information from the magnetic stripe on the payment account card, from a smart card using contact pads, contactlessly from a near-field communication (NFC) device, or from manual entry and communicate electronically with the transaction processing computers of acquirer 120. Alternatively, acquirer 120 can authorize a third party to perform transaction processing on its behalf. In this case, the point-of-sale terminal can be configured to communicate with the third party. Such a third party can be referred to as a “merchant processor” or an “acquiring processor.”

As embodied herein, using payment network 140, the computers of acquirer 120 or the merchant processor can communicate information regarding payment card transactions with computers of the issuer 130. For example and not limitation, information regarding payment card transactions can include an authorization request 125 and an authorization response 135. An authorization request 125 can be communicated from the computers of the acquirer 120 to the computers of issuer 130 to determine whether the cardholder's account is in good standing and whether the purchase is covered by the cardholder's available credit line or account balance. Based on these determinations, the authorization request 125 can be declined or accepted, and an authorization response 135 can be transmitted from the issuer 130 to the acquirer 120, and then to the merchant, ATM, or website 110. The authorization request 125 can include account information identifying the merchant, location information (e.g., an address of the merchant), and transaction information, as discussed herein. The authorization response 135 can include, among other things, a result of the determination that the transaction is approved or declined and/or information about the status of the payment card or payment account.

For example and not limitation, at least one payment network server 150 can be connected to the electronic payment network 140 and configured to automatically capture the data representing a plurality of variables related to payment card transactions from the electronic payment network 140. As embodied herein, the payment network server 150 can be configured to only capture the data representing a plurality of variables related to payment card transactions with the permission of the cardholder. Additionally, the payment network server 150 can be configured to only capture the information regarding payment card transactions in accordance with applicable data privacy laws.

FIG. 2 depicts a block diagram illustrating a representative system 200 for performing proactive currency exchange according to an illustrative embodiment of the disclosed subject matter. The exemplary system 200 can include at least a cardholder device 202, a payment card network server 204, an issuer server 206, a currency exchange server 208, and newsfeeds 220 which can all communicate with each other over network 230 and/or multiple networks such as network 230. Network 230 may be a wireless network, local area network, the world wide web, or any other suitable network.

As embodied herein, the cardholder device 202 can be a certain user device that an account member (e.g., a member of a financial institution such as a holder of a MasterCard®—branded payment card issued by a bank) uses to manage his or her member account. For example, the cardholder device 202 can be a mobile computing device (e.g., laptop, smartphone, tablet, PDA, etc.), a telephone, a desktop computer, or any other device that the account member uses to manage his or her member account and/or conduct electronic transactions. The cardholder device 202 can have a customized application (e.g., e-banking mobile application) that facilitates a secure connection between the cardholder device 202 and the payment card network sever 204 and/or issuer server 206 (e.g., a server associated with the issuer financial institution that issued the payment card) over network 230.

As embodied herein, the payment card network server 204 can be one or more servers that processes payment card transactions and/or manages the communications between the issuer server 206 and the cardholder device 202. In some embodiments, the payment card network server 204 can facilitate the proactive currency exchange disclosed herein. In some embodiments, the payment card network server 204 can include one or more of a processor 210, a risk identification engine 212, a fee calculation engine 214, a notification engine 216, and a currency management engine 218. In some embodiments, the processor 210 can work in tandem with the risk identification engine 212, the fee calculation engine 214, the notification engine 216, and the currency management engine 218 to facilitate the proactive currency exchange.

In some embodiments, the processor 210 can instruct the risk identification engine 212 to identify one or more potential risk events indicative of social, political, and economic risk that can cause the local and/or current currency of the financial institution to fluctuate and/or be subject to sudden inflation. For example, the risk identification engine 212 can monitor multiple different newsfeeds 220 and other sources of information (e.g., financial news, social media platforms, news channels, etc.) to identify the presence of recent events that can have a potential effect on the local and/or current currency. For example, the risk identification engine 212 can identify that a political uprising is in progress by monitoring social media platforms such as Twitter and Facebook as well as newsfeeds such as Associated Press, Reuters, etc. The risk identification engine 212 can identify the type of event associated with the news story by identifying the metadata and/or parsing the content associated with the news (e.g., metadata and/or keywords indicating that the type of event is a political uprising and/or attempted coup). In some embodiments, the risk identification engine 212 can predict and/or identify a level of risk of sudden currency value and/or exchange volume fluctuations by aggregating as much information about currently occurring events and/or recently occurred events in the region of the account member. For example, the risk identification engine 212 can be programmed with preset rules and/or risk scoring algorithms that include instructions on calculating a level of risk to currency fluctuations based on the types of events detected from different information sources. In some embodiments, the risk identification engine 212 can receive and/or be configured to calculate the quantity, average and total amount of recent requests to convert one specific currency to another currency within a specific time period from several different cardholders for their respective member accounts. Based on the amount of recent requests that risk identification engine 212 receives to perform a proactive currency exchange identified by the risk identification engine 212, the risk identification engine 212 can modify the level of risk (e.g., increase the risk level if the number of recent requests exceeds a predetermined threshold and/or vice versa). In some embodiments, the risk identification engine 212 can perform such risk identification for all regions of the world in which the payment card network's associated account members (e.g., cardholders) are located. For example, the risk identification engine 212 can identify the current location of its different account members from their user profile information and/or from location information (e.g., GPS data) received from the cardholder device 202. The risk identification engine 212 can compare the level of determined risk to currency fluctuation against a preset risk threshold to determine if there is a substantial risk to currency fluctuations that the members need to take actions to safeguard the funds in their member accounts that are in the form of the local and/or current currency that is subject to fluctuation. In some embodiments, the cardholder can proactively pre-set instructions to conduct a proactive currency exchange when pre-specified criteria by the cardholder are met. These pre-specified criteria can include scores that indicate increased risk where the contributing factors used in calculating the risk assessment score can include posts about economic, political, and social instability from mining social media platforms and from text mining mass media content, an increase in volume of foreign currency exchange, and analyzing other sources of information indicating economic, political, and social instability. In some embodiments, the risk identification engine 212 can determine the level of risk to the current currency based on the information collected by the monitoring by using statistical techniques (e.g., clustering, profile-and-predictive linear-and-nonlinear regressions, etc.) to develop bespoke algorithms that can quantify and aggregate risk, political risk, social risk, currency risk, etc. based on the monitored information. The risk identification engine 212 can also calculate statistically based scores for automated and subject matter expert monitoring.

In some embodiments, once the processor 210 has identified that a substantial risk exists to the local and/or current currency of an account member, the processor 210 can instruct the notification engine 216 to send a notification message to the prepaid payroll and/or pre-loaded gift-card cardholder (e.g., through the cardholder device 202) that a risk of local and/or current currency devaluation is present. For example, the notification engine 216 can send a text message, automated call, email, and/or smartphone notification alert message to the cardholder device 202 with a message indicating that the local and/or current currency of the account member may be at risk. In other embodiments, the notification engine 216 can generate a message and/or alert to be displayed within an e-banking application (e.g., an e-banking application associated with the issuer bank and/or an e-banking application associated with the payment card) executing on the cardholder device 202 when the cardholder opens such an application on his or her cardholder device 202.

In some embodiments, the processor 210 can instruct the notification engine 216 to provide a notification message to the account member with an option that the account member can select to initiate a request for a currency exchange from the local and/or current currency that is at risk to an alternative currency and/or currency basket (e.g., a selection of multiple alternative currencies). For example, under the instruction of the processor 210, the notification engine 216 can generate a display of an option within an e-banking application on the cardholder device 202 to perform a currency exchange from the local and/or current currency at risk to one or more alternative currencies. Additionally or alternatively, under the instruction of the processor 210, the notification engine 216 can send a text message, an automated call, email, and/or smartphone notification alert message to the cardholder device 202 with an option to the account member to initiate a request to perform a currency exchange from the local and/or current currency to one or more alternative currencies. The payment card network server 204 can identify and recommended alternative currencies that have a higher likelihood of having a higher relative stability using the risk identification engine 212 and/or by querying other currency rating sources to provide an indication of seemingly more stable alternative currencies and/or commodities (e.g., precious metals, oil, etc.). The different alternative currencies provided as options to the account member for the currency exchange can be currencies that are accepted in a region in which the account member is permanently or temporarily located, and/or will be located following voluntary or involuntary emigration. The cardholder can specify such a location of future emigration through the cardholder device 202.

In some embodiments, the processor 210 can instruct the fee calculation engine 214 to determine a fee to facilitate the currency exchange from the local and/or current currency subject to risk to at least one or more alternative currencies. In some embodiments, the processor 210 can charge a percentage of the funds to be exchanged as the currency exchange fee. In some other embodiments, the processor 210 can charge a percentage of the funds to be exchanged as the currency exchange fee up to a maximum threshold amount. In some other embodiments, the processor 210 can charge a flat fee as the currency exchange fee regardless of the amount of the funds to be exchanged.

In some embodiments, upon receiving a request from the account member (e.g., from the cardholder device 202), the processor 210 can instruct the currency exchange management engine 218 to facilitate the proactive currency exchange of the account member's funds from the local and/or current currency to an alternative currency. Upon receiving a request to perform a currency exchange, the currency exchange management engine 218, under the direction of the processor 210, can identify, from the request, which alternative currencies the local and/or current currency is to be exchanged into and the amount of funds to be exchanged from the local and/or current currency into each of the alternative currencies specified in the request. For example, the account member can select one or more alternative currencies from a list of alternative currencies into which they wish either a portion or all of their local and/or current currency funds to be exchanged. In an exemplary embodiment, upon receiving a request from the account member to exchange the local and/or current currency into two different alternative currencies, the currency exchange management engine 218 can instruct the currency exchange server to exchange a first portion of the funds from the local and/or current currency to a first amount in a first alternative currency and exchange a second portion of the funds from the local and/or current currency into a second amount in a second alternative currency. In some embodiments, the second currency can simply be the currency and/or currency basket assessed as most stable currency and/or currency basket at the time of the transaction (e.g., proactive currency exchange). The currency exchange management engine 218 can receive from the account member, in the request, a selection of the at least one alternative currency from the one or more different alternative currencies. Additionally or alternatively, the currency exchange management engine 218 can identify and proportionally assign current currency fractions to new alternative currency fractions creating a basket of currencies from the current currency or currencies, as per the request. For example, the cardholder can change the currencies and/or the percentage allocation of currencies at which the assets and/or funds in the member account are to be exchanged for current and/or future deposits into the member account.

In some embodiments, upon receiving a request to perform a currency exchange, the currency exchange management engine 218, under the direction of the processor 210, can determine whether there are sufficient funds in the member account to perform the requested currency exchange. The processor 210 can determine the currency exchange fee from the fee calculation engine 214. The processor 210 can transmit a message to the issuer server 206 associated with the financial institution of the member account indicating an exchange fee for performing the proactive currency exchange. The processor 210 can also transmit, to the issuer server 206, a query to determine whether there are sufficient funds in the member account to cover the funds to be exchanged into the alternative currency and the exchange fee. In response to the message and/or query, the processor 210 can be configured to receive, from the issuer server 206, a return message indicating whether there are sufficient funds in the member account to cover the funds to be exchanged into alternative currency and the exchange fee. For example, the issuer server 206 can check whether the funds in the member account exceeds the sum of the exchange fee and the funds to be exchanged, as identified by the payment card network server 204.

In some embodiments, the currency exchange management engine 218, under the direction of the processor 210, can instruct the issuer (e.g., issuer server 206) of the member account to provide the funds to be exchanged from the member account to a third-party financial institution (e.g., currency exchange server 208). The currency exchange management engine 218, under the direction of the processor 210, can instruct the third-party financial institution to exchange the funds provided by the issuer from the local and/or current currency to an amount of exchanged funds in the alternative currency. The currency exchange management engine 218, under the direction of the processor 210, can instruct the third-party financial institution to transmit the amount of exchanged funds in the alternative currency from the third-party financial institution to the issuer for deposit in the member account.

In some embodiments, the member account can be associated with a payment card (e.g., credit card, debit card, pre-paid debit card, pre-loaded gift card, payroll card to which an employer can deposit period payroll payments, etc.). The disclosed subject matter can be used with a pre-paid card (e.g., a pre-paid payroll card or a gift card). The disclosed subject matter can also be used with a credit card in which, as an example, an excess payment is made to the credit card exceeding the balance amount, creating a positive balance amount above a debt or zero amount that favors the cardholder. In some embodiments, the positive balance on the pre-paid card and/or credit card can be exchanged into multiple different currencies or a single new alternative currency from the current and/or local currency in which the positive balance is in presently. Once the currency exchange occurs, at least a portion of the funds accessible to the payment card that were requested to be exchanged from the member account, can be in the alternative currency. Transactions that are conducted using the payment card at any time after the proactive currency exchange has occurred can be conducted in the alternative currency or any currency through industry-known dynamic currency exchange processes coordinated by the issuer or merchant. Accordingly, in the event of a continuous long-term currency devaluation, or in the event of a sudden catastrophic collapse of the local and/or current currency, account members who have exchanged the local and/or current currency in their member accounts can be insulated from the catastrophic effects of devaluation and/or loss of funds in their payment card accounts and can conduct transactions in the alternative currency using their payment cards. For example, if the cardholder is traveling from his or her current location to a new location as part of an emigration, funds in the member account that are in the local and/or current currency can be proactively exchanged for a currency that is used in the new location where the cardholder will be located.

In some embodiments, deposits made to the member account in the local and/or current currency after the request is received can be automatically exchanged into the at least one alternative currency when pre-specified conditions are met. For example, when the risk processor 210 identifies that a reoccurring deposit has occurred, and/or when the risk identification engine 212 identifies and/or predicts an increase in the current currency risk score and/or political risk scores based on mining social media platforms and/or mass media content, the processor 210 can determine that the pre-set conditions have been met and can instruct the currency exchange management engine 218 to perform a proactive currency exchange. The proactive currency exchange can be automatically performed in this manner whenever a pre-set criteria is triggered until a request to stop performing the proactive currency exchange is received from the account member. For example, certain account members can be paid by their employers with local and/or current currency that is direct deposited into their payment card accounts. Additionally or alternatively, a deposit in the form of a refund from a merchant can be made to the cardholder's member account. If the account member has initiated a request to perform proactive currency exchange from the local and/or current currency into an alternative currency, subsequent funds deposited into the member account in the local and/or current currency can be exchanged, at the time of deposit and/or when pre-specified criteria have been met or exceeded, into the alternative currency previously selected by the account member unless the account member has requested to stop performing such automatic currency exchange into the alternative currency.

FIG. 3 is a flow chart illustrating a representative method 300 implemented according to an illustrative embodiment of the disclosed subject matter. The exemplary network 100 of FIG. 1 and system 200 of FIG. 2, for purpose of illustration and not limitation, are discussed with reference to the exemplary method of FIG. 3.

As embodied herein, at 302, the processor can determine whether a local and/or current currency is subject to fluctuation above a predetermined level. For example, the risk identification engine 212 can identify a level of risk of sudden currency fluctuations by aggregating as much information about currently occurring events and/or recently occurred events in the region of the account member. The risk identification engine 212 can compare the level of determined risk of currency fluctuation against a preset risk threshold to determine if there is a substantial risk of currency fluctuations that the members need to take actions to safeguard the funds in their member accounts that are in the form of the local and/or current currency subject to fluctuation and/or based on a determination of whether pre-set criteria thresholds have been met.

At 304, the processor can provide an account member with an option to request to exchange funds in the local and/or current currency to an alternative currency. For example, the processor 210 can instruct the notification engine 216 to send a notification message to the cardholder (e.g., through the cardholder device 202) that a risk of local and/or current currency devaluation is present. The notification engine 216 can generate a display of an option within an e-banking application on the cardholder device 202 to perform a currency exchange from the local and/or current currency at risk to one or more alternative currencies. In some embodiments, the proactive currency exchange can also occur automatically at the time when the processor 210 determines that pre-set criteria have been met.

At 306, the processor can receive a request from an account member to exchange funds in the member account from a local and/or current currency of the funds into an alternative currency. For example, the processor can receive, from the cardholder device 202, a request to exchange funds in the member account from the local and/or current currency to an alternative currency selected by the account member. Upon receiving a request to perform a currency exchange, the currency exchange management engine 218, under the direction of the processor 210, can identify, from the request, which alternative currencies the local and/or current currency is to be exchanged into and the amount of funds to be exchanged from the local and/or current currency into each of the alternative currencies specified in the request.

At 308, the processor can determine whether there are sufficient funds in the member account to perform the requested currency exchange. For example, the processor 210 can transmit, to the issuer server 206, a query to determine whether there are sufficient funds in the member account to cover the funds to be exchanged into the alternative currency and the exchange fee. In some embodiments, the issuer server 206 can check whether the funds in the member account exceeds the sum of the exchange fee and the funds to be exchanged, as identified by the payment card network server 204 and indicate such information to the processor 210 in a return message.

At 310, in response to determining that the member account does have sufficient funds to perform the requested currency exchange, the processor can instruct the issuer of the member account and the currency exchange server to perform the currency exchange from the local and/or current currency to the alternative currency. For example, the currency exchange management engine 218, under the direction of the processor 210, can instruct the issuer server 206 to provide the funds to be exchanged from the member account to the third-party currency exchange server 208. The currency exchange management engine 218, under the direction of the processor 210, can instruct the third-party financial institution to exchange the funds provided by the issuer from the local and/or current currency to an amount of exchanged funds in the alternative currency. The currency exchange management engine 218, under the direction of the processor 210, can instruct the third-party currency exchange server 208 to transmit the amount of exchanged funds in the alternative currency from the third party financial institution to the issuer for deposit in the member account (e.g., a pre-paid debit card, gift card, payroll card, or a debit balance held on a credit card's balance).

At 312, in response to determining that the member account does not have sufficient funds to perform the requested currency exchange, the processor can provide a notification to the account member that the member account lacks sufficient funds to perform the requested currency exchange.

At 314, the processor can determine that local and/or current currency was deposited into the member account. For example, certain account members can be paid by their employers with local and/or current currency that is direct deposited into their payment card accounts. The processor 210 can determine if additional local and/or current currency was added to the member account by monitoring the issuer server 206.

At 316, the processor can determine whether a request to stop exchanging currency from the local and/or current currency to the alternative currency has been received from the account member. If the processor determines that such a request to stop exchanging currency has been received, the method 300 ends and the amount deposited into the member account in step 314 remains in the form of the local and/or current currency that was deposited. However, if the processor determines that no such requested to stop exchanging currency has been received, the method 300 proceeds back to step 308 to determine whether the member account has sufficient funds to exchange the funds that were deposited in step 314 to the member account.

FIG. 4 is a block diagram illustrating further details of a representative computer system according to an illustrative embodiment of the disclosed subject matter.

The systems and techniques discussed herein can be implemented in a computer system. As an example and not by limitation, as shown in FIG. 4, the computer system having architecture 400 can provide functionality as a result of processor(s) 401 executing software embodied in one or more tangible, non-transitory computer-readable media, such as memory 403. The software implementing various embodiments of the present disclosure can be stored in memory 403 and executed by processor(s) 401. A computer-readable medium can include one or more memory devices, according to particular needs. Memory 403 can read the software from one or more other computer-readable media, such as mass storage device(s) 435 or from one or more other sources via communication interface 420. The software can cause processor(s) 401 to execute particular processes or particular parts of particular processes described herein, including defining data structures stored in memory 403 and modifying such data structures according to the processes defined by the software. An exemplary input device 433 can be, for example, a keyboard, a pointing device (e.g., a mouse), a touchscreen display, a microphone and voice control interface, or the like to capture user input coupled to the input interface 423 to provide data and/or user input to the processor 401. An exemplary output device 434 can be, for example, a display (e.g., a monitor) or speakers coupled to the output interface 424 to allow the processor 401 to present a user interface, visual content, and/or audio content. Additionally or alternatively, the computer system 400 can provide an indication to the user by sending text or graphical data to a display 432 coupled to a video interface 422. Furthermore, any of the above components can provide data to or receive data from the processor 401 via a computer network 430 coupled the communication interface 420 of the computer system 400. In addition or as an alternative, the computer system can provide functionality as a result of logic hardwired or otherwise embodied in a circuit, which can operate in place of or together with software to execute particular processes or particular parts of particular processes described herein. Reference to software or executable instructions can encompass logic, and vice versa, where appropriate. Reference to a computer-readable media can encompass a circuit (such as an integrated circuit (IC)) storing software or executable instructions for execution, a circuit embodying logic for execution, or both, where appropriate. The present disclosure encompasses any suitable combination of hardware and software.

In some embodiments, processor 401 includes hardware for executing instructions, such as those making up a computer program. As an example and not by way of limitation, to execute instructions, processor 401 can retrieve (or fetch) the instructions from an internal register, an internal cache 402, memory 403, or storage 408; decode and execute them; and then write one or more results to an internal register, an internal cache 402, memory 403, or storage 408. In particular embodiments, processor 401 can include one or more internal caches 402 for data, instructions, or addresses. This disclosure contemplates processor 401 including any suitable number of any suitable internal caches, where appropriate. As an example and not by way of limitation, processor 401 can include one or more instruction caches 402, one or more data caches 402, and one or more translation lookaside buffers (TLBs). Instructions in the instruction caches 402 can be copies of instructions in memory 403 or storage 408, and the instruction caches 402 can speed up retrieval of those instructions by processor 401. Data in the data caches 402 can be copies of data in memory 403 or storage 408 for instructions executing at processor 401 to operate on; the results of previous instructions executed at processor 401 for access by subsequent instructions executing at processor 401 or for writing to memory 403 or storage 408; or other suitable data. The data caches 402 can speed up read or write operations by processor 401. The TLBs can speed up virtual-address translation for processor 401. In some embodiments, processor 401 can include one or more internal registers for data, instructions, or addresses. This disclosure contemplates processor 401 including any suitable number of any suitable internal registers, where appropriate. Where appropriate, processor 401 can include one or more arithmetic logic units (ALUs); be a multi-core processor; or include one or more processors 401. Although this disclosure describes and illustrates a particular processor, this disclosure contemplates any suitable processor.

In some embodiments, memory 403 includes main memory for storing instructions for processor 401 to execute or data for processor 401 to operate on. As an example and not by way of limitation, computer system 400 can load instructions from storage 408 or another source (such as, for example, another computer system 400) to memory 403. Processor 401 can then load the instructions from memory 403 to an internal register or internal cache 402. To execute the instructions, processor 401 can retrieve the instructions from the internal register or internal cache 402 and decode them. During or after execution of the instructions, processor 401 can write one or more results (which can be intermediate or final results) to the internal register or internal cache 402. Processor 401 can then write one or more of those results to memory 403. In some embodiments, processor 401 executes only instructions in one or more internal registers or internal caches 402 or in memory 403 (as opposed to storage 408 or elsewhere) and operates only on data in one or more internal registers or internal caches or in memory 403 (as opposed to storage 408 or elsewhere). One or more memory buses (which can each include an address bus and a data bus) can couple processor 401 to memory 403. Bus 440 can include one or more memory buses, as described below. In particular embodiments, one or more memory management units (MMUs) reside between processor 401 and memory 403 and facilitate accesses to memory 403 requested by processor 401. In some embodiments, memory 403 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 403 can include one or more memories 404, where appropriate. Although this disclosure describes and illustrates particular memory, this disclosure contemplates any suitable memory.

In some embodiments, storage 408 includes mass storage for data or instructions. As an example and not by way of limitation, storage 408 can include a hard disk drive (HDD), a floppy disk drive, flash memory, an optical disc, a magneto-optical disc, magnetic tape, or a Universal Serial Bus (USB) drive or a combination of two or more of these. Storage 408 can include removable or non-removable (or fixed) media, where appropriate. Storage 408 can be internal or external to computer system 400, where appropriate. In some embodiments, storage 408 is non-volatile, solid-state memory. In some embodiments, storage 408 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 408 taking any suitable physical form. Storage 408 can include one or more storage control units facilitating communication between processor 401 and storage 408, where appropriate. Where appropriate, storage 408 can include one or more storages 408. Although this disclosure describes and illustrates particular storage, this disclosure contemplates any suitable storage.

In some embodiments, input interface 423 and output interface 424 can include hardware, software, or both, providing one or more interfaces for communication between computer system 400 and one or more input device(s) 433 and/or output device(s) 434. Computer system 400 can include one or more of these input device(s) 433 and/or output device(s) 434, where appropriate. One or more of these input device(s) 433 and/or output device(s) 434 can enable communication between a person and computer system 400. As an example and not by way of limitation, an input device 433 and/or output device 434 can include a keyboard, keypad, microphone, monitor, mouse, printer, scanner, speaker, still camera, stylus, tablet, touch screen, trackball, video camera, another suitable input device 433 and/or output device 434 or a combination of two or more of these. An input device 433 and/or output device 434 can include one or more sensors. This disclosure contemplates any suitable input device(s) 433 and/or output device(s) 434 and any suitable input interface 423 and output interface 424 for them. Where appropriate, input interface 423 and output interface 424 can include one or more device or software drivers enabling processor 401 to drive one or more of these input device(s) 433 and/or output device(s) 434. Input interface 423 and output interface 424 can include one or more input interfaces 423 or output interfaces 424, where appropriate. Although this disclosure describes and illustrates a particular input interface 423 and output interface 424, this disclosure contemplates any suitable input interface 423 and output interface 424.

As embodied herein, communication interface 420 can include hardware, software, or both providing one or more interfaces for communication (such as, for example, packet-based communication) between computer system 400 and one or more other computer systems 400 or one or more networks. As an example and not by way of limitation, communication interface 420 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 420 for it. As an example and not by way of limitation, computer system 400 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 400 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 can include any suitable communication interface 420 for any of these networks, where appropriate. Communication interface 420 can include one or more communication interfaces 420, where appropriate. Although this disclosure describes and illustrates a particular communication interface, this disclosure contemplates any suitable communication interface.

In some embodiments, bus 440 includes hardware, software, or both coupling components of computer system 400 to each other. As an example and not by way of limitation, bus 440 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 440 can include one or more buses 404, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within its spirit and scope.

1. A method for performing currency exchange, comprising:
receiving, by a processor, a request from an account member to exchange at least a portion of funds in a cardholder member account from a current currency of the funds to at least one alternative currency;
responsive to receiving the request, determining whether there are sufficient funds in the cardholder member account to perform the requested currency exchange;
performing a proactive currency exchange to exchange at least the portion of funds in the cardholder member account from the current currency to the at least one alternative currency.

2. The method of claim 1, wherein the current currency is the local currency associated with a current location of the cardholder, wherein the alternative currency is a currency that is determined to have a level of stability above a preset threshold, and wherein the cardholder member account is associated with at least one of a pre-paid debit card, reloadable debit card, gift card, credit card with a positive credit, and payroll card.

3. The method of claim 1, further comprising:
determining, by a processor, whether the current currency is subject to fluctuation above a predetermined level; and
transmitting, by the processor, notification information to a user device associated with the account member, wherein the notification information indicates that the current currency of the account member is subject to fluctuation and provides an option for the account member to initiate a request to exchange at least the portion of the funds in the cardholder member account from the current currency to the at least one alternative currency.

4. The method of claim 3, wherein determining whether the current currency of the account member is subject fluctuation further comprises calculating a level of risk by:
monitoring a plurality of internal transactional and non-transactional data, customer inquiries, social media content, and news information sources for events indicating at least one of social risk, political risk, natural disasters, and economic risk; and
determining the level of risk to the current currency based on the monitoring by using statistical techniques that quantify the level of risk based on monitored information.

5. The method of claim 1, wherein performing the proactive currency exchange further comprises exchanging a first portion of the funds from the current currency to a first amount in a first alternative currency and exchanging a second portion of the funds from the current currency into a second amount in a second alternative currency, wherein the account member indicates criteria to be used to perform automated proactive currency exchange when the criteria are met, and wherein the account member indicates the first portion and the second portion in the request, and wherein the account member specifies the first alternative currency and the second alternative currency in the request.

6. The method of claim 1, wherein the account member is provided with one or more different alternative currencies from which to select to perform the proactive currency exchange, the method further comprising receiving, from the account member, a selection of the at least one alternative currency from the one or more different alternative currencies.

7. The method of claim 6, wherein the one or more different alternative currencies provided to the account member are currencies accepted in at least one of a first region in which the account member is located and a second region to which the account member is likely to relocate based upon migratory patterns of refugees and stateless populations.

8. The method of claim 1, wherein performing the proactive currency exchange further comprises:
instructing, by the processor, an issuer of the cardholder member account to provide at least the portion of the funds from the cardholder member account to a third party financial institution;
instructing, by the processor, the third-party financial institution to exchange the at least the portion of the funds provided by the issuer from the current currency to an amount of exchanged funds in the at least one alternative currency;
instructing, by the processor, the third-party financial institution to transmit the amount of exchanged funds in the at least one alternative currency from the third party financial institution to the issuer for deposit in the cardholder member account.

9. The method of claim 1, wherein the cardholder member account is associated with a payment card and wherein transactions conducted using the payment card after the proactive currency exchange are conducted in the at least one alternative currency.

10. The method of claim 1, wherein deposits made to the cardholder member account in the current currency after the request is received are automatically exchanged into the at least one alternative currency until a request to stop performing the proactive currency exchange is received from the account member.

11. The method of claim 1, wherein determining whether there are sufficient funds in the cardholder member account to perform the requested currency exchange further comprises:
transmitting, by the processor, a message to an issuer of the cardholder member account indicating an exchange fee for performing the proactive currency exchange and a query to determine whether there are sufficient funds in the cardholder member account to cover at least the portion of the funds to exchange into the at least one alternative currency and the exchange fee; and
in response to transmitting the message to the issuer, receiving, by the processor and from the issuer, a return message indicating whether there are sufficient funds in the cardholder member account to cover at least the portion of the funds to be exchanged into the at least one alternative currency and the exchange fee.

12. An apparatus for performing a currency exchange, comprising:
a communication module configured to communicate with a currency exchange server;
a processor, coupled to the communication module, and configured to:
receive a request from a cardholder account member to exchange at least a portion of funds in a member account from a current currency of the funds to at least one alternative currency;
responsive to receiving the request, determine whether there are sufficient funds in the member account to perform the requested currency exchange;
instruct the currency exchange server to perform a proactive currency exchange to exchange at least the portion of funds in the member account from the current currency to the at least one alternative currency.

13. The apparatus of claim 12, wherein the current currency is the local currency associated with a current location of the cardholder, wherein the alternative currency is a currency that is determined to have a level of stability above a preset threshold, and wherein the member account is associated with at least one of a pre-paid debit card, reloadable debit card, gift card, credit card with a positive credit, and payroll card.

14. The apparatus of claim 12, wherein the processor is further configured to:
determine whether the local and/or current currency is subject to fluctuation above a predetermined level; and
transmit notification information to a user device associated with the account member, wherein the notification information indicates that the local and/or current currency of the account member is subject to fluctuation and provides an option for the account member to initiate a request to exchange at least the portion of the funds in the member account from the local and/or current currency to the at least one alternative currency.

15. The apparatus of claim 14, wherein the processor is configured to determine whether the local and/or current currency of the account member is subject fluctuation further comprises calculating a level of risk by further being configured to:
monitor a plurality of news information sources for events indicating at least one of social risk, political risk, and economic risk in conjunction with customer inquiries and transactions in a specific time period, and a volume of the customer inquiries and transactions over two or more time periods, and
determine the level of risk to the current currency based on the monitoring.

16. The apparatus of claim 12, wherein the processor is configured to:
perform the proactive currency exchange by further being configured to exchange a first portion of the funds from the current currency to a first amount in a first alternative currency and exchanging a second portion of the funds from the local and/or current currency into a second amount in a second alternative currency, and
wherein the processor is further configured to identify, from the request, an indication of the first portion, the second portion, the first alternative currency, and the second alternative currency that is specified by the account member in the request.

17. The apparatus of claim 12, wherein the processor is configured to perform the proactive currency exchange by further being configured to:
instruct, using the communication module, an issuer server associated with an issuer of the member account to provide at least the portion of the funds from the member account to a currency exchange server of a third-party financial institution;
instructing, using the communication module, the currency exchange server of the third-party financial institution to exchange the at least the portion of the funds provided by the issuer from the current currency to an amount of exchanged funds in the at least one alternative currency;
instruct, using the communication module, the currency exchange server of the third party financial institution to transmit the amount of exchanged funds in the at least one alternative currency from the third party financial institution to the issuer server associated with the issuer for deposit in the member account.

18. The apparatus of claim 12, wherein the processor is further configured to:
determine whether a preset criteria for proactive currency exchange has been met;
in response to determining that the preset criteria has been met, instruct the currency exchange server to perform proactive currency exchange on deposits made to the member account in the current currency after the request is received into the at least one alternative currency until the processor receives a request to stop performing the proactive currency exchange from the account member.

19. The apparatus of claim 12, wherein the processor is configured to determine whether there are sufficient funds in the member account to perform the requested currency exchange by further being configured to:
transmit, using the communication module, a message to an issuer server associated with an issuer of the member account indicating an exchange fee for performing the proactive currency exchange and a query to determine whether there are sufficient funds in the member account to cover at least the portion of the funds to exchange into the at least one alternative currency and the exchange fee; and
in response to transmitting the message to the issuer server, receiving, using the communications module and from the issuer server, a return message indicating whether there are sufficient funds in the member account to cover at least the portion of the funds to be exchanged into the at least one alternative currency and the exchange fee.

20. A network for performing proactive currency exchange, comprising:
a cardholder device of a cardholder;
a currency exchange server of a third-party financial institution; and
a payment processing computer system configured to:
receiving, from the cardholder device, a request to exchange at least a portion of funds in a member account of the cardholder from a current currency of the funds to at least one alternative currency;
responsive to receiving the request, determine whether there are sufficient funds in the member account to perform the requested currency exchange; and
instruct the currency exchange server to perform a proactive currency exchange to exchange at least the portion of funds in the member account from the current currency to the at least one alternative currency.
